(19) United States
(12) Patent Application Publication
(10) Pub. No.: US 2026/0228761 A1
(43) Pub. Date: Aug. 6, 2026

(54) CUSTOMER CONVERSATION DATA MANAGEMENT PLATFORM

(71) Applicant: EXOTEL TECHCOM PRIVATE LIMITED, Bengaluru (IN)

(72) Inventors: DARSHAN DATT KIKKERI SHIVADATTA, Bengaluru (IN); SHIVAKUMAR GANESAN, Bengaluru (IN); ANIL KUMAR AGARA VENKATESHA RAO, Bengaluru (IN); SACHIN BHATIA, Bengaluru (IN); MOHIT SINGH JAMWAL, Bengaluru (IN)

(21) Appl. No.: 19/426,120

(22) Filed: Dec. 19, 2025

(30) Foreign Application Priority Data
Jan. 28, 2025 (IN) 202541006767

(51) Int. Cl. G06Q 30/0201; G06F 40/30; H04L 51/216

(52) U.S. Cl. CPC G06Q 30/02011; G06F 40/30; H04L 51/216

(57) ABSTRACT

A computer-implemented method for managing customer conversation data is described. In an example, customer interaction data may be received from a plurality of communication channels corresponding to multiple business systems. The customer interaction data is associated with a plurality of customers. Further, the received customer interaction data is stored in a data store. Furthermore, the customer interaction data is grouped based on at least one of a topic, a timeline, and a user profile. For each group of customer interaction data, the group is analyzed to derive customer insights of the group. The customer insights of each group or across a plurality of groups can be analyzed to determine a state of a customer relationship of a customer or a set of customers with a company. Based on the analysis of the customer insights, a recommendation corresponding to the state of the customer relationship is generated.

### TECHNICAL FIELD

The present disclosure relates to customer interaction management, and more particularly relates to a system and method for managing customer conversation data.

### BACKGROUND

Customers can interact with a company through various channels like phone calls, emails, social media, website chat, and in-person interactions. Companies often use different systems to manage different business processes and each one of these different systems may use different combinations of communication channels. For example, companies may have separate systems for customer support, marketing campaigns, sales pipeline management, and the like. Further, each of these systems may use one or any combination of a phone call, SMS, email, social media message, and the like. Since each of these systems is optimized for its specific area of focus and not on customer experience, such systems only capture data relevant to their context.

### BRIEF DESCRIPTION OF THE DRAWINGS

FIG. 1 is a block diagram of an example system, depicting a conversation data management module to manage customer conversation data by consolidating the conversation data from various business systems and/or various communication channels used by the business systems;

FIG. 2 is a block diagram of another example system, depicting components of a customer conversation data platform (CCDP) to manage customer conversation data;

FIG. 3 is an example process, depicting a hierarchical structure for summarizing and organizing interaction data;

FIG. 4 is an example system, depicting a contextual analysis and monitoring unit to derive the customer insights of a group of interaction data using an artificial intelligence (AI) model;

FIG. 5 is an example system, depicting a contextual analysis and monitoring unit to derive the customer insights of a group of interaction data using non-AI based techniques;

FIG. 6 is a block diagram, depicting a demo application showcasing capabilities of the CCDP of FIG. 2;

FIG. 7 is a flow diagram illustrating an example method for managing customer conversation data; and

FIG. 8 is a block diagram of an example computing device including non-transitory computer-readable storage medium storing instructions to manage customer conversation data.

The drawings described herein are for illustrative purposes and are not intended to limit the scope of the present subject matter in any way.

### DETAILED DESCRIPTION

Examples described herein may provide an enhanced computer-based method, technique, and system to manage customer conversation data by consolidating the conversation data from various communication channels used by different business systems. The paragraphs to present an overview of the business systems, existing methods to manage customer conversation data associated with the business systems, and drawbacks associated with the existing methods.

Companies often use separate business systems to manage different business processes and each one of these different systems may use different combinations of communication channels (e.g., email, chat, phone call, and the like). For example, the business systems encompass customer support systems, marketing campaign systems, sales lifecycle management systems, and the like.

Each of these systems is optimized for its specific area of focus and hence only captures data relevant to their context. For example, a customer might contact support/sales through a chat window on the website, but their purchase history might only be accessible in the sales pipeline management system. With separate systems, each system might capture only a portion of the customer's information. This creates an incomplete customer profile, making it difficult for companies to understand the customers’ preferences and needs. Also, the companies may have to navigate separate systems, which can be frustrating and time-consuming.

With dedicated business systems in place for different business processes, capturing a holistic view of customer perception towards the company can be challenging. For instance, a customer might complain about an inability to visit a company branch during a support call. However, this valuable feedback is often not readily available to marketing teams, who could otherwise pitch priority accounts to the customer thereby increasing upsells. Marketing tools typically focus on data points that predict a customer's buying behavior, while support ticket resolutions might only capture information specific to the resolved issue. Additionally, even if Customer Relationship Management (CRM) tool exists, the exchange of customer information across these systems might be limited in terms of timeliness and comprehensiveness. Further, the influence of stakeholder KPIs on data management can lead to data manipulation based on the performance metrics prioritized by different company actors.

Thus, the use of different systems can make it difficult for companies to: Get a complete view of the customer interactions: Representatives might not have all the information about a customer's past interactions when the information is scattered across different systems. Improve customer service: Representatives might not have access to a customer's history, making it harder to personalize service or resolve issues efficiently. Analyze customer behavior: It's more challenging to understand customer trends and preferences if the customer's past interactions aren't consolidated. Deliver consistent and positive customer interactions across various touchpoints (e.g., marketing, sales, support, and the like) due to lack of complete customer context.

In some existing methods, the information about the customer's past interactions is stored in CRM systems. Several integration methods exist for the CRM systems, which help manage the customer information. However, the CRM systems may lag behind other systems as the data synchronization between systems and the CRM is not always real-time. Further, the CRM systems can include basic customer details like name, contact information, purchase history, and past service interactions. This context is helpful but limited. The limitations of CRM systems may include: Limited Scope: It focuses on factual information like name, contact details, and past transactions. This doesn't capture the "why" behind the customer's actions or their current state of mind. Static Information: It's a snapshot in time and may not reflect the customer's current situation or needs. A customer who bought a product a year ago might have different needs now. Focus on Transactions, Not Relationships: It primarily tracks interactions related to purchases and service issues. It doesn't capture the overall customer sentiment or relationship with the company.

For example, the CRM context may tell who the customer is, but it doesn't tell what they're feeling or why they could be contacting you. This lack of depth can hinder the representative’s ability to truly understand and serve the customers effectively.

Examples described herein may provide a computer-implemented method for managing customer interaction data. The method may include receiving the customer interaction data from a plurality of communication channels corresponding to multiple business systems. The customer interaction data may be associated with a plurality of customers. Further, the method includes storing the received customer interaction data in a data store and grouping the customer interaction data based on at least one of a topic, a timeline, and a user profile. For each group of customer interaction data, the method may include analyzing the group to derive customer insights of the group. Furthermore, the method may include analyzing the customer insights of each group or across a plurality of groups to determine a state of a customer relationship (e.g., of a customer or a plurality of customers) with a company. Based on the analysis of the customer insights, the method may include generating a recommendation corresponding to the state of the customer relationship.

Thus, examples described herein can provide an automated system (e.g., a Customer Conversation Data Platform (CCDP)) that acts as a central hub for all customer data within an enterprise. This unified data can then be easily accessed and leveraged by various applications across the organization, fostering a consistent and enhanced customer experience. The CCDP also empowers real-time conversation analysis, allowing businesses to summarize and understand customer feelings as conversations unfold (i.e., real-time conversation analysis). By monitoring scenario driven insights, businesses can gain a significant edge, enabling them to personalize customer service, anticipate customer needs, and proactively address potential issues.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

The terms “customer interaction data” and “customer conversation data” are used interchangeably throughout the document and refer to any recordings or representations of interactions that capture exchange of information in a conversation between company and the customer. In this example, human agents or bots may be interacting with the customer on behalf of the company.

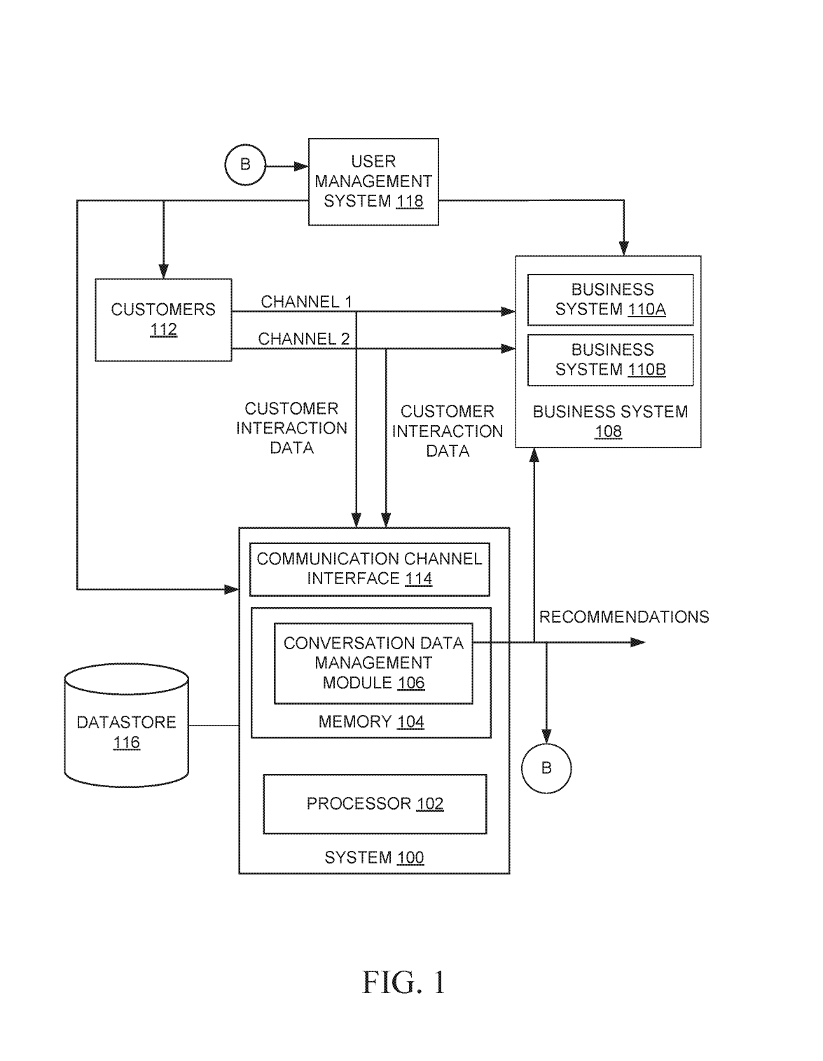

Referring now to the figures, FIG. 1 is a block diagram of an example system 100, depicting a conversation data management module 106 to manage customer interaction data by consolidating the interaction data from various business systems and/or various communication channels used by the business systems (e.g., business system 110A and business system 110B). Example system 100 may include a computing device such as, but are not limited to, portable, mobile, or other devices such as mobile phones (including smartphones), laptop computers, desktop computers, tablet computers, server computers, mainframes, and the like.

System 100 includes a processor or processing unit 102 and a memory 104 that is communicatively coupled to processor 102. Memory 104 includes conversation data management module 106. Further, system 100 includes a communication channel interface 114 and a data store 116 communicatively coupled to processor 102. During operation, communication channel interface 114 may be configured to receive customer interaction data from a plurality of communication channels corresponding to multiple business systems 110A and 110B. The customer interaction data may be associated with a plurality of customers. Further, data store 116 may be configured to store the received customer interaction data associated with multiple business systems 110A and 110B.

The customer interaction data may refer to any recordings or representations of interactions that capture exchange of information in a conversation. This can include audio data from voice interactions such as phone calls and voice assistants, as well as text-based data from emails, social media messages, website chat logs, and transcribed in-person conversations. A business system 110A or 110B is a system that enables organizations to deliver business value to the customer. Various business systems together are involved across the entire customer journey. An example business system 110A or 110B may include customer management system, a marketing campaign management system, a sales pipeline management system, and the like. Further, a user management system 118 can help organizations create and manage identities for all the users, including employees and customers. The user management system 118 also manages various functionalities that each user can access within the enterprise. Various business systems as well as the example system 100 refer to user management system for user authentication and authorization data.

Such business systems 110A and 110B can interact with the customers through various communication channels. These channels may include phone, email, messaging, social media, website search, website chatbot, in-person interactions, online conferencing, self-service portals, rule-based voice assistant interactions, or AI-based voice assistant interactions. In such examples, communication channel interface 114 may receive the customer interaction data from conversations between customers and human agents or chatbots.

In an example, processing unit 102 can intercept the customer interaction data in real-time from the plurality of communication channels corresponding to multiple business systems 110A and 110B and store the intercepted customer interaction data in data store 116. In this example, “Intercepting” refers to capturing the customer interaction data in real-time, rather than passively receiving it after the interaction. In other words, the customer interaction data is captured from the channels as the conversation happens. In some examples intercepting the interaction data may include making changes to the communication channels to allow for such interruptions without any overheads on cost or performance. In other examples intercepting the interaction may include duplicating the channels to allow for interaction data to flow to both business ystem 108 as well as the system 100 (e.g., a customer conversation data platform (CCDP)). In some examples, business systems 110A and 110B may refer to software programs that the companies use to manage customer interactions. In this example, processing unit 102 can tap into data from various business systems directly and/or via various communication channels to get a holistic view of the customer's experience.

In another example, processing unit 102 can collect the customer interaction data from multiple databases linked to the multiple business systems 110A and 110B and the communication channels, and then store the received customer interaction data in data store 116.

Further, conversation data management module 106 may group the customer interaction data based on at least one of a topic, a timeline, and a user profile. Customer interaction data may include the information gathered from conversations between a business system 108 and its customers 112. This can come from various sources (e.g., channels 1 and 2 as shown in FIG. 1) like phone calls, emails, chats, social media, and the like. To make sense of this vast amount of data, it's crucial to organize it in meaningful ways. Conversation data management module 106 may group the customer interaction data based on one or more of the following:

By topic, which involves grouping interactions based on a subject matter such as product inquiries, customer complaints, order issues, feedback, and the like.

By time, which involves grouping interactions based on time periods such as daily interactions, weekly trends, monthly performance, yearly overview.

By user profile, which involves grouping interactions based on customer information such as customer segments (e.g., age, location, gender), customer behavior (e.g., purchase history, browsing patterns), customer value (e.g., spending habits), customer sentiment (e.g., satisfaction level), and the like.

Grouping can involve constructing a graph-like structure where nodes represent interactions and links indicate the nature of relationship between these interactions. This can create a hierarchical representation of the overall conversation.

For each group of customer interaction data, conversation data management module 106 may analyze the group to derive insights of the group. In an example, for each group of customer interaction data, conversation data management module 106 may analyze the group using an Artificial Intelligence (AI) model to derive the insights of the group. The AI model may utilize machine learning techniques like deep learning to learn from large amounts of conversation data and extract insights such as summary, state, intent, and vibe of specific conversations as well as nature and state of relationship of the group of customers with the enterprise.

In another example, for each group of customer interaction data, conversation data management module 106 may analyze the group using a natural language processing (NLP) model and a rule-based system to derive the insights of the group. In this example, for each group of customer interaction data, conversation data management module 106 may extract data including semantic meaning from each group of customer interaction data using the NLP model and apply a set of rules (e.g., associated with the rule-based system) to the extracted data to derive the insights of the group. The NLP may rely on rule-based systems using statistical analysis to identify keywords and patterns. In this example, the NLP may extract meaning from conversations, while rules-based systems can be applied after the NLP to analyse the extracted data for specific conversational insights (e.g., identifying threats or profanities based on pre-defined rules).

Both the NLP and AI techniques can be used to analyze the customer conversations for negative sentiment, keywords indicating potential issues, recurring themes, and the like and provide valuable insights for improving the customer service. The solution also facilitates to gain insights into conversation, both at topic and the conversation levels.

In some examples, the insights may include a next action, summary of a conversation, sentiment of the conversation, rule-based insights of the conversation, or any combination thereof. For example, the insights may include an intent of participants in a conversation, an outcome of the conversation, a vibe underlying the conversation, or any combination thereof.

Further, conversation data management module 106 may analyze the insights of each group or across a plurality of groups to determine a state of a customer relationship of a customer or a set of customers with a company. Based on the analysis of the insights, conversation data management module 106 may generate a recommendation corresponding to the state of the customer relationship. In an example, conversation data management module 106 may generate the recommendation corresponding to a set of product improvements or a set of process improvements or a set of customer(s) communication recommendations to drive improved customer satisfaction and/or business outcomes for the company. Furthermore, the conversation data management module 106 may use Artificial Intelligence (AI) model or NLP/Rule engines to generate these recommendations. Further, the recommendation may be provided to various subscribers such as business system 108, user management system 118, and the like.

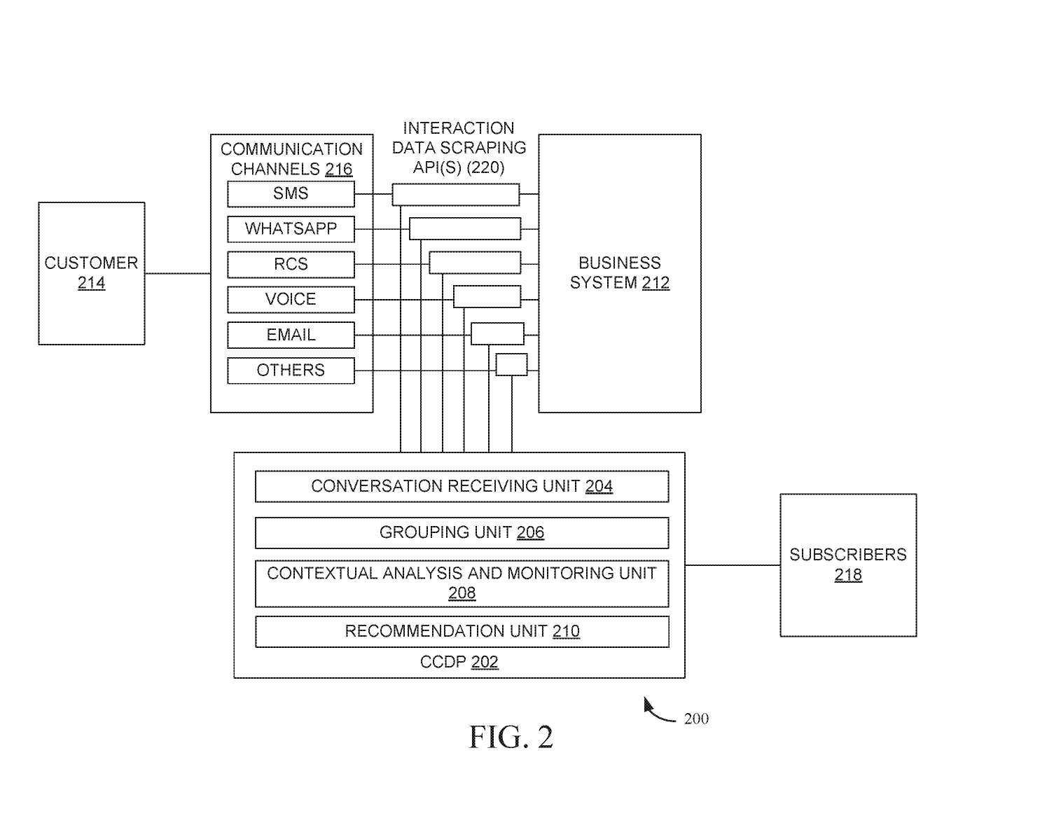

FIG. 2 is a block diagram of another example system 200, depicting components of a customer conversation data platform (CCDP) 202 (e.g., conversation data management module 106 of FIG. 1) to manage the customer conversation data. As shown in FIG. 2, CCDP 202 includes a conversation receiving unit 204, a grouping unit 206, a contextual analysis and monitoring unit 208, and a recommendation unit 210.

Every company interacts with its customers 214 through different systems (e.g., business systems 212 such as contact center, marketing campaign, ticketing system, and the like) and over different communication channels 216 such as short message service (SMS), WhatsApp, rich communication service (RCS), voice, email, social media, website chat, in-person interactions, and the like.

During operation, conversation receiving unit 204 may utilize application programming interfaces (APls) (220) to consolidate customer interaction data from various communication channels 216 into a central location (e.g., a centralized customer data repository), where all the customer interaction data is stored. For example, the central location can be a database, a data lake, or another type of data warehouse. The APIs can consolidate the customer interaction data from communication channels 216 at the data level before preparing it for usage in different business systems specific to their contexts.

The interaction data scrapping APIs 220 may be a modification to the communication channel APIs to keep the scrapping overhead minimum or can be scrappers on top of databases of business systems.

In some examples, CCDP 202 may include a speech recognition engine to convert audio conversations to text for the conversational analysis. Further, grouping unit 206 may group the consolidated customer interaction data for at least one of customer profile, or a topic or timeline. In an example, grouping refers to organizing the customer interactions into categories for easier analysis and understanding. Consider that the CCDP 202 may have a year's worth of emails or chats pertaining to a single customer. In this case, a grouped and chronological list can help us see patterns and extract valuable insights. The customer information can be grouped in different ways as shown below:

a) Grouping by topic: This approach treats all conversations related to a specific event for a single customer(e.g., a food order for a food delivery company) as a single topic. It focuses on capturing the overall experience associated with the event. In this example, conversation related to each order is one topic. Consider User X placed 2 orders. In this case, the grouping may include:

o Order 1 (March): All conversations from various channels (e.g., email, chat, phone) related to this order are grouped together as "Order 1. The conversations may include ordered shoes via the mobile app (confirmation), emailed sizing concerns (transcript grouped), received SMS notification on shipment, negative website review citing delayed delivery (categorized), and so on.

o Order 2 (June): All conversations related to this order are grouped under "Order 2”. For example, the conversations may include purchased gift basket online (website), chatted with support for a personalized gift card message (transcript grouped), a call to inquire about a recipient address change (recording included).

b) Grouping by Timeline (Chronological Grouping): This method organizes conversations chronologically, creating a historical record of interactions. Consider an index of conversations with a customer for a year. The conversations that happened at the beginning of the year may not be related to the conversation that happened at the later part of the year. This approach provides a clear picture of how the customer relationship developed throughout the year and helps identify recurring issues or inquiries at specific points in the year (e.g., seasonal product launches). This approach also visualizes changes in the customer sentiment towards the company or product.

c) Grouping by customer profile: This method organizes conversations related to customer profiles. A customer profile could mean a set of customers of a certain profile, for example, male or female, young or old, customer satisfaction levels, location, or it could mean a specific individual as well. In one example an apparel company may choose to group all conversations for its female customers between ages of 18 to 24 to understand adoption of its products in the said category.

Furthermore, contextual analysis and monitoring unit 208 may analyze consolidated customer interaction data for each group or across a plurality of groups to derive and monitor conversation summaries and sentiment. An example process for capturing the summary and sentiment to capture the intent of all parties involved in the conversation, state (i.e., result of the conversation), and the vibe (i.e., emotional tone underlying the conversation). For example, contextual analysis and monitoring unit 208 analyses each interaction to derive the summary and sentiment of the interaction. In another example, contextual analysis and monitoring unit 208 analyses the group of interactions (e.g., topics) to derive the summary and state of the group of interactions.

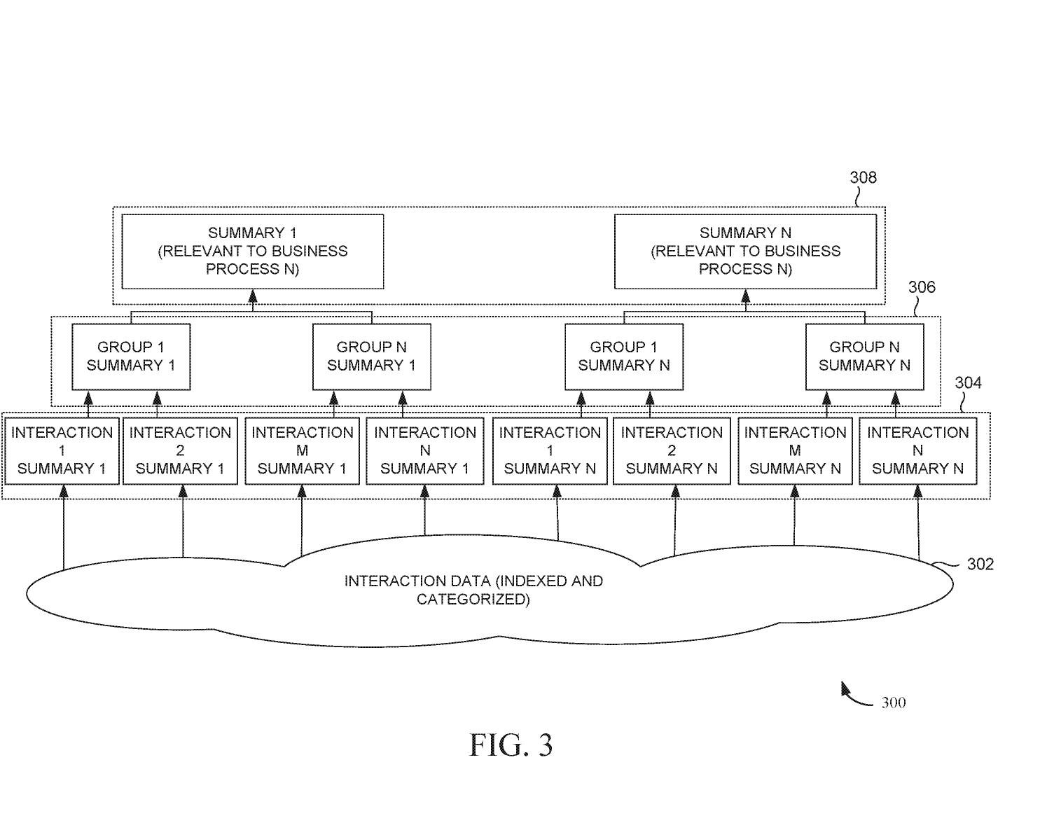

Further, summaries and sentiment across topics can be analyzed to understand a state of customer vis-a-vis the company. Further the summaries and sentiment can be tailored to different business processes relevant to the organisation. By monitoring the summaries and sentiment across conversations and topics, companies can improve customer service (e.g., understand customer needs and provide targeted solutions), personalize marketing (e.g., deliver relevant offers and content based on customer preferences), increase sales (e.g., identify sales opportunities and personalize interactions with potential customers), and the like. An example process for capturing the summary and sentiment is explained in FIG. 3.

Further, CCDP 202 may enable subscribers 218 to sign up for customer insights (i.e., summaries and sentiment). Subscribers can include various business systems, customer champions, department heads such as marketing head, support head and/or business heads in an enterprise. CCDP 202 subscription may empower subscribers 218 to understand customers on a whole new level. By analyzing conversation summaries and sentiment, recommendation unit 210 can tailor recommendations that directly address subscribers’ needs. In some examples, recommendation unit 210 may use generative AI technologies to ensure that the recommendations correspond to the sentiment related to the user. Recommendation unit 210 can provide the following example recommendations to the subscribers 218:

a. Contextual Connections: Need help maximizing a specific product feature mentioned? The recommendation unit will suggest relevant accessories or complementary items to enhance the customer experience.

b.

c. Predictive Picks: Based on the past interactions, the recommendation unit can identify similar products or services the customer might be interested in, making future explorations even more efficient.

d. Sentiment-Sensitive Support: Customer feeling frustrated with a particular aspect? Our recommendations will help the stake holders adjust accordingly, and steer the conversations towards resources that address the concerns or similar experiences others have encountered.

e. Nudge for timely interventions: Rules can be set to monitor conversations and escalate to commensurate levels if conversations breach certain rule thresholds.

FIG. 3 is an example process 300, depicting a hierarchical structure for summarizing and organizing interaction data. As shown in FIG. 3, the interaction data is gathered from various sources and stored, at 302. This data represents individual interactions or events. The collected interaction data is tagged and indexedfor efficient retrieval and analysis.

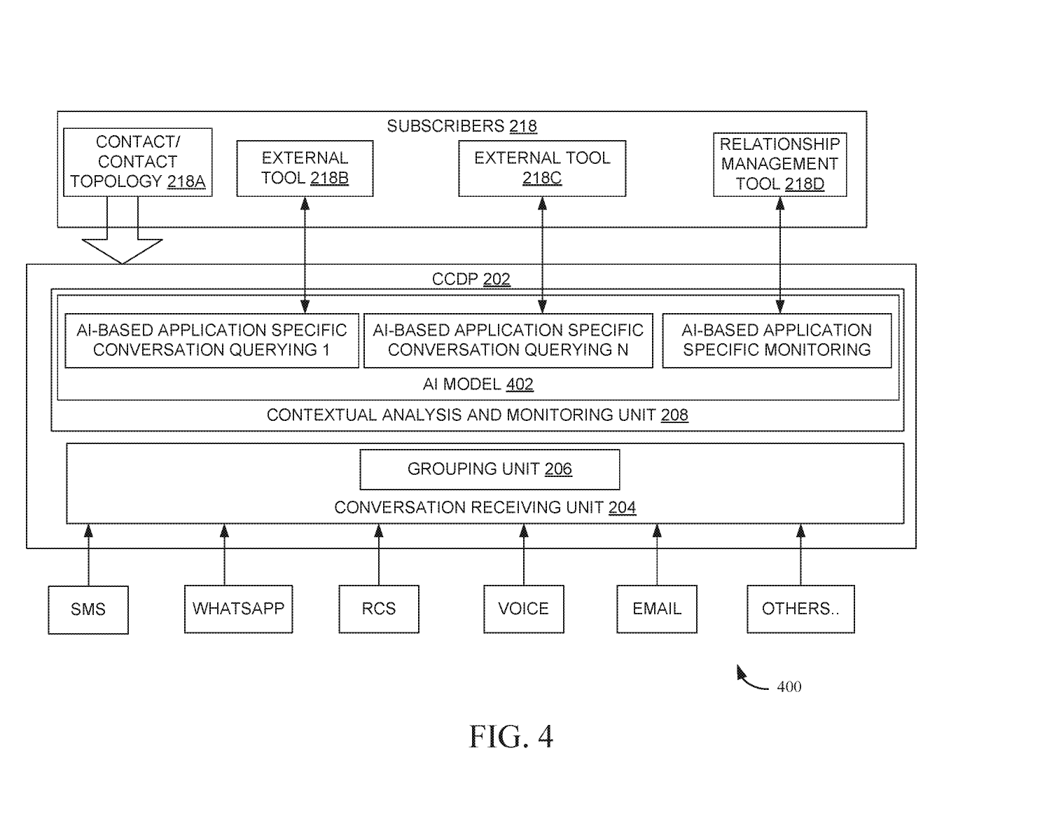

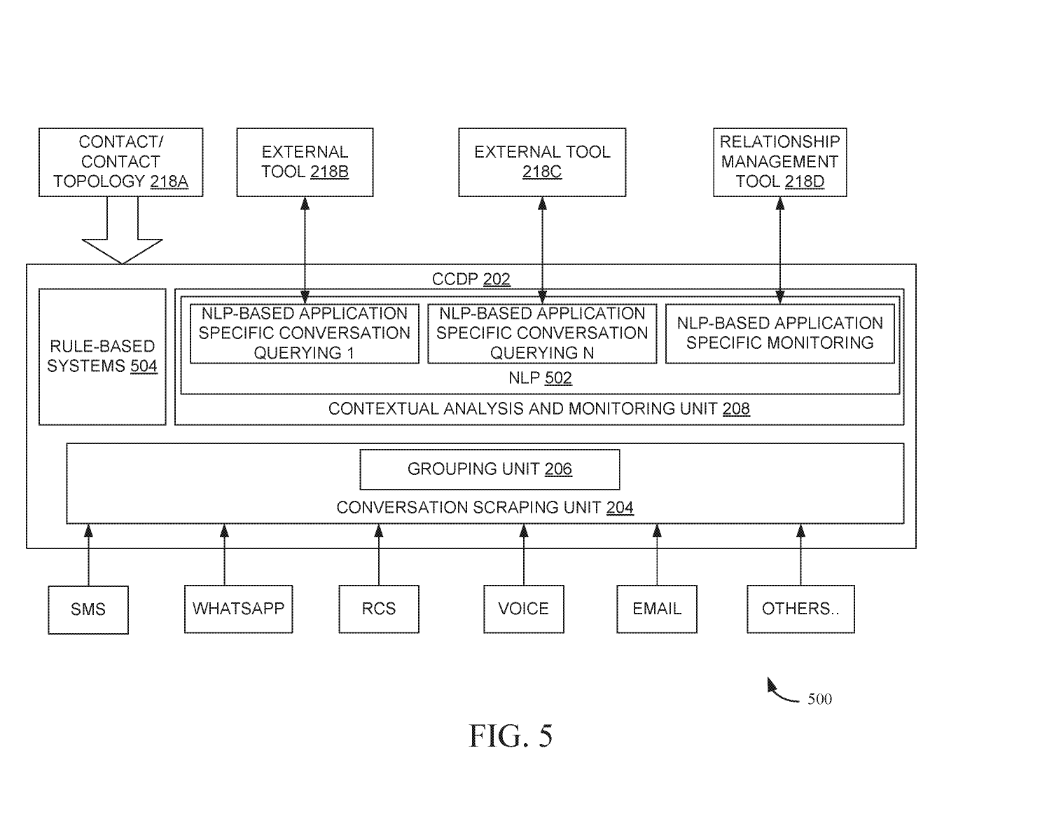

At 304, the stored interaction data (e.g., interaction 1 summary 1, interaction 2 summary 1, and so on) may be collected for analysis. At 306, the interaction data may be organized into relevant categories or groups (e.g., group 1 summary 1, group N summary 1, and so on) based on specific criteria such as a topic, a timeline, and/or a user profile. At 308, conversation summaries and sentiment (e.g., summary 1, summary N, and so on) relevant to a business process may be generated by analyzing customer interaction data for each group or across a plurality of groups. The grouped conversational information can be analyzed using various techniques, such as AI-based application specific conversation as explained in FIG. 4 or non-AI based techniques as explained in FIG. 5.

FIG. 4 is an example system 400, depicting a contextual analysis and monitoring unit 208 to derive the customer insights of a group of interaction data using an AI model. Similarly named elements of FIG. 4 are similar in function and/or structure to the elements described in FIG. 2. In an AI-based approach, context analysis and monitoring unit 208 leverages powerful machine learning techniques, including deep learning, large language models and/or small language models to extract valuable insights from conversations. Context analysis and monitoring unit 208 may use AI model 402 to analyze the grouped conversational information to derive and continuously monitor the state, intent, and vibe for all interactions. In an example, context analysis and monitoring unit 208 may analyze the grouped conversational information to derive the state, intent, and vibe for all interactions using AI-based application specific conversation querying 1-N. Further, context analysis and monitoring unit 208 may monitor the state, intent, and vibe for all interactions using AI-based application specific monitoring methods.

Further, the state, intent, and vibe can be derived for each set of interactions corresponding to a topic to generate the state, intent and vibe related to the overall topic. State, intent and vibe from multiple topics related to the customer can then be analyzed to derive the overall sentiment related to the user. Based on use cases or business processes under consideration, specific aspects of the conversations can be focused upon to derive the sentiment relevant to the business process.

Further, the context analysis and monitoring unit 208 may pre-generate and cache the hierarchical state intent and vibe for predefined set of use cases or can generate the state intent and hierarchy just in time upon query. The context analysis and monitoring unit 208 may allow for combinations of the above to cater to different operational considerations of query speed, accuracy and cost trade-offs.

The AI-based approach can be beneficial for analyzing application-specific conversations. For example, a contact center tool (e.g., tools 218A-218C) could leverage CCDP 202 to analyze the complete communication history between a customer and the service provider (i.e., the company). This historical context allows for deeper insights than analyzing limited set of interactions.

In another example, a relationship management tool 218D can benefit significantly from AI-based analysis of CCDP 202. By monitoring the overall sentiment across all communications, CCDP 202 can identify instances where the sentiment becomes negative or exceeds a predetermined threshold.

In some examples, CCDP 202 can analyze the communication history to extract valuable insights such as:

o Overall Sentiment: Is the customer generally satisfied or dissatisfied based on past interactions?

o Sentiment Trends: Is the sentiment improving or declining over time?

o Keywords and Phrases: Are there specific keywords or phrases that indicate potential issues or concerns?

o Profanity Detection: Are there instances of offensive language being used?

In other examples, CCDP 202 can be configured to send real-time alerts and notifications. For example, CCDP 202 can notify a relationship manager if a customer's sentiment worsens or if specific concerning keywords are detected. Thus, CCDP’s AI-based context analysis provides a powerful tool for analyzing customer conversations, leading to an improved customer service, proactive issue resolution, and stronger customer relationships.

FIG. 5 is an example system 500, depicting a contextual analysis and monitoring unit 208 to derive the customer insights of a group of interaction data using non-AI based techniques. Similarly named elements of FIG. 4 are similar in function and/or structure to the elements described in FIGS. 2 and 3. In the non-AI based approach, context analysis and monitoring unit 208 uses a natural language processing 502 that relies on predefined rules to identify keywords and patterns. In this example, context analysis and monitoring unit 208 uses the natural language processing 502 to extract features like keywords, phrases, named entities (locations, people), or syntactic structures from the grouped conversation. Then, rule-based systems 504 analyze these features and make decisions based on defined conditions (e.g., identifying threats or profanities based on rules). Hierarchical summary and sentiment (e.g., state, intent, and vibe) construction and business process specific construction techniques may also be employed for NLP based analysis in CCDP 202.

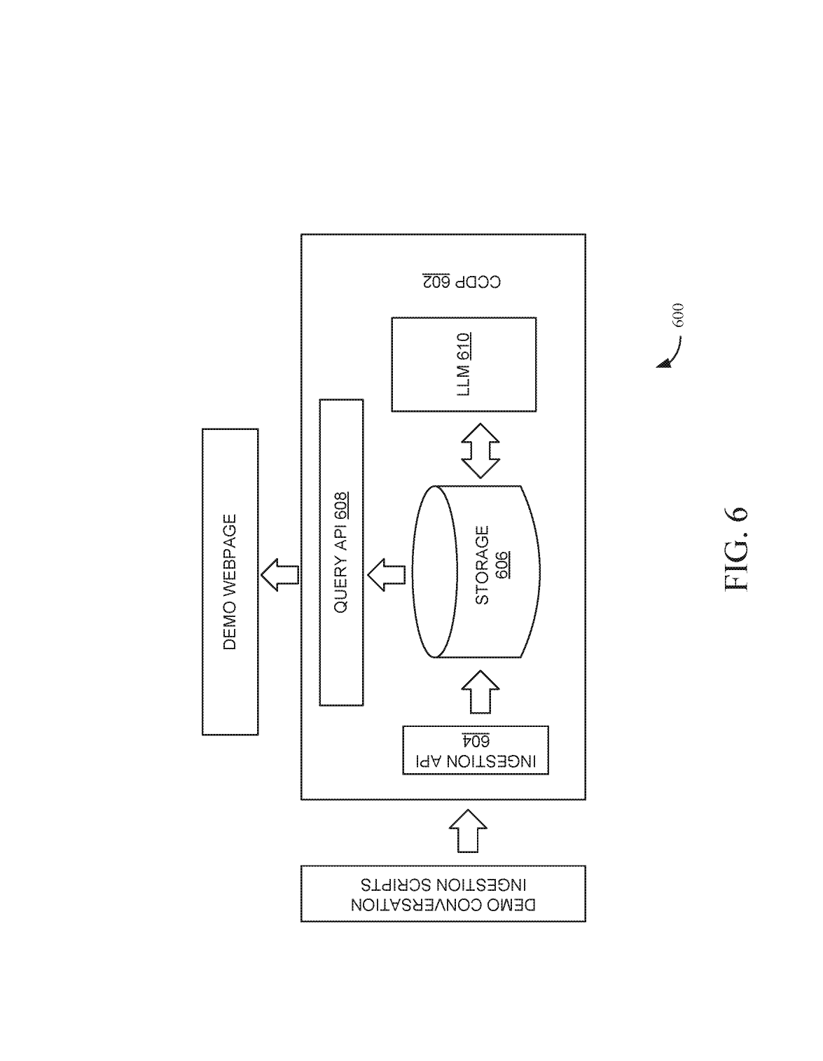

FIG. 6 is a block diagram 600, depicting a demo application showcasing capabilities of CCDP 602 (e.g., CCDP 202 of FIG. 2). As shown in FIG. 6, CCDP 602 may include an ingestion API 604, a storage 606, a query API 606, and a large language model (LLM) 610. During operation, ingestion API 604 may receive customer information from various sources via conversation ingestion scripts and store the customer information into storage 606. Further, the demo application may create a comprehensive index of all customer conversations in storage 606, making it easy to access and analyze all interactions with a specific customer.

Related conversations are automatically grouped by topic, timeline, and/or user profile, making it easier to understand the overall conversation flow and identify key themes within each customer interaction. For each customer, the demo application establishes a clear timeline of all conversations, allowing to track interactions over time and identify trends.

Further, query API 608 can handle user queries. Query API 608 may interact with storage 606 to retrieve relevant data and then processes that data using LLM 610 to generate responses. In response to receiving a user query via query API 608, CCDP 602 may utilize LLM 610 to analyze customer information stored in storage 606 to derive and monitor conversation summaries and sentiment for each interaction. Furthermore, CCDP 602 may generate recommendations corresponding to summaries and sentiment and outputs the recommendations via a webpage.

Thus, CCDP 602 may provide valuable insights from each conversation and topic across a conversation. Example insights may include a concise overview of the conversation's key points, an overall emotional tone of the conversation (e.g., positive, negative, or neutral) at both the conversation and topic level, and the like.

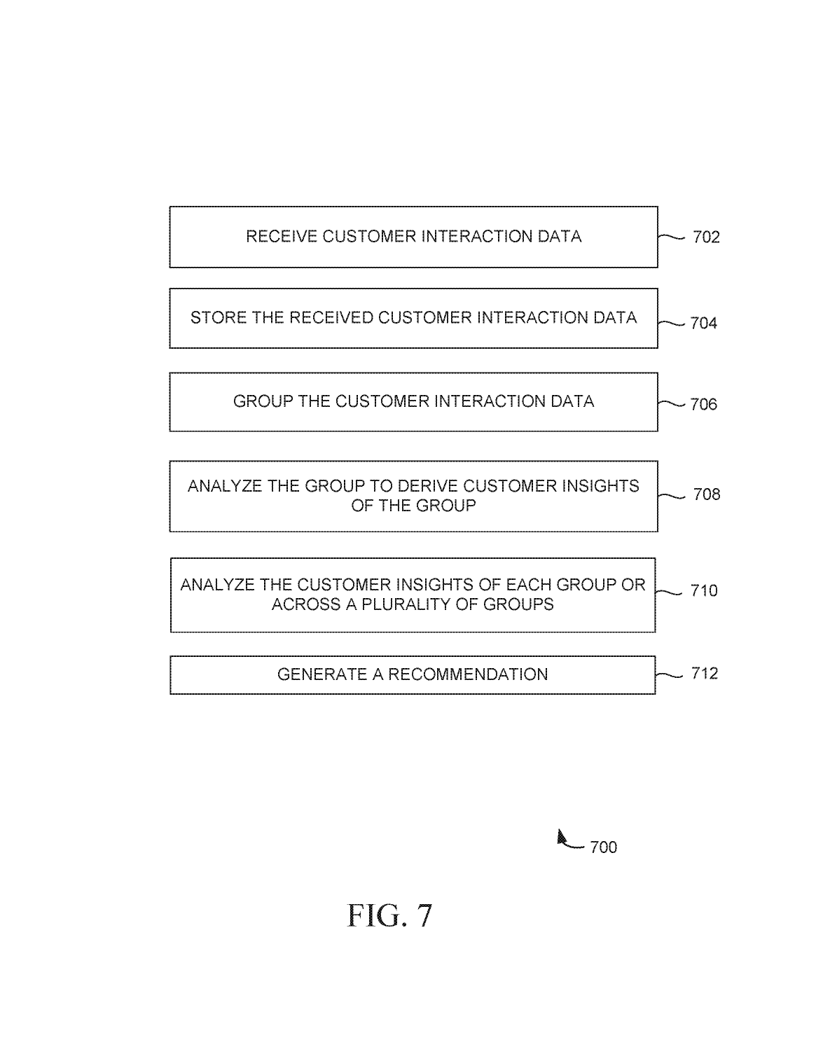

FIG. 7 is a flow diagram illustrating an example method 700 for managing customer conversation data. Example method 700 depicted in FIG. 7 represents generalized illustrations, and other processes may be added, or existing processes may be removed, modified, or rearranged without departing from the scope and spirit of the present application. In addition, method 700 may represent instructions stored on a computer-readable storage medium that, when executed, may cause a processor to respond, to perform actions, to change states, and/or to make decisions. Alternatively, method 700 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 702, customer interaction data may be received from a plurality of communication channels corresponding to multiple business systems. The customer interaction data is associated with a plurality of customers. At 704, the received customer interaction data may be stored in a data store. In an example, receiving the customer interaction data may include intercepting the customer interaction data in real-time from the plurality of communication channels corresponding to multiple business systems. Each of the plurality of communication channels may include one of a phone, email, messaging, social media, website search, website chatbot, in-person interaction, online conferencing, self-service portal, rule-based voice assistant interaction, or AI-based voice assistant interaction.

At 706, the customer interaction data may be grouped based on at least one of a topic, a timeline, and a user profile. For each group of customer interaction data, at 708, the group may be analyzed to derive customer insights of the group. The customer insights may include summary of a conversation, sentiment of the conversation, rule-based insights of the conversation, or any combination thereof. For example, the group may be analyzed to determine an intent of participants in a conversation, an outcome of the conversation, a vibe underlying the conversation, or any combination thereof.

In an example, for each group of customer interaction data, the group may be analyzed using an Artificial Intelligence (AI) model to derive the customer insights of the group. In another example, for each group of customer interaction data, the group may be analyzed using a natural language processing (NLP) model and a rule-based system to derive the customer insights of the group. In this example, for each group of customer interaction data, data including semantic meaning from each group of customer interaction data may be extracted using the NLP model. Further, a set of rules may be applied to the extracted data to derive the customer insights of the group.

In some examples, prior to analyzing each group of customer interaction data, an audio portion of the customer interaction data in each group may be converted to text using a speech recognition engine.

At 710, the customer insights of each group or across a plurality of groups may be analyzed to determine a state of a customer relationship of a customer or a set of customers with a company. Based on the analysis of the customer insights, at 712, a recommendation corresponding to the state of the customer relationship may be generated. In an example, the recommendation corresponding to the state of the customer relationship may be generated using an Artificial Intelligence (AI) model.

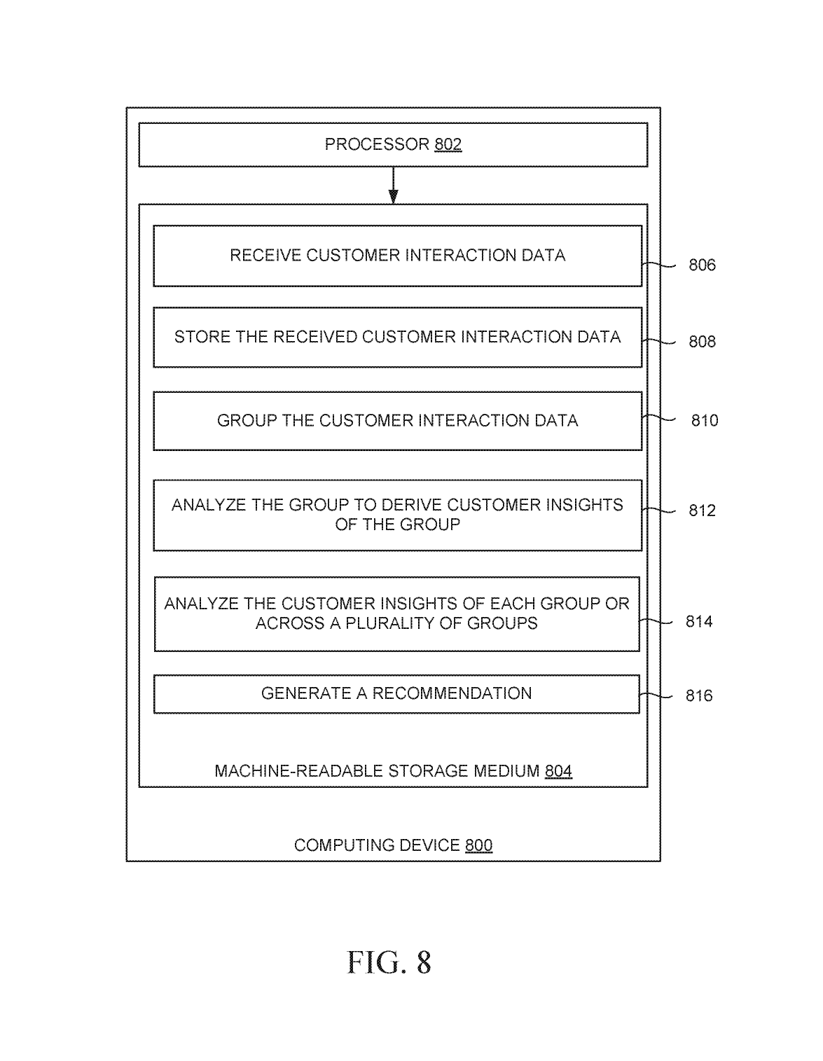

FIG. 8 is a block diagram of an example computing device 800 including non-transitory computer-readable storage medium storing instructions to manage customer conversation data. Computing device 800 may include a processor 802 and computer-readable storage medium 804 communicatively coupled through a system bus. Processor 802 may be any type of central processing unit (CPU), microprocessor, or processing logic that interprets and executes computer-readable instructions stored in computer-readable storage medium 804. Computer-readable storage medium 804 may be a random-access memory (RAM) or another type of dynamic storage device that may store information and computer-readable instructions that may be executed by processor 802. For example, computer-readable storage medium 804 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 804 may be a non-transitory computer-readable medium. In an example, computer-readable storage medium 804 may be remote but accessible to computing device 800.

Computer-readable storage medium 804 may store instructions 806, 808, 810, 812, 814, and 816. Instructions 806 may be executed by processor 802 to receive customer interaction data from a plurality of communication channels corresponding to multiple business systems. The customer interaction data is associated with a plurality of customers. Instructions 808 may be executed by processor 802 to store the received customer interaction data in a data store.

Instructions 810 may be executed by processor 802 to group the customer interaction data based on at least one of a topic, a timeline, and a user profile. Instructions 812 may be executed by processor 802 to analyze, for each group of customer interaction data, the group to derive customer insights of the group. Instructions 814 may be executed by processor 802 to analyze the customer insights of each group or across a plurality of groups to determine a state of a customer relationship of a customer or a set of customers with a company.

Based on the analysis of the customer insights, instructions 816 may be executed by processor 802 to generate a recommendation corresponding to the state of the customer relationship.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method for managing customer conversation data, the method comprising:
receiving customer interaction data from a plurality of communication channels corresponding to multiple business systems, wherein the customer interaction data is associated with a plurality of customers;
storing the received customer interaction data in a data store;
grouping the customer interaction data based on at least one of a topic, a timeline, and a user profile;
for each group of customer interaction data, analyzing the group to derive customer insights of the group ;
analyzing the customer insights of each group or across a plurality of groups to determine a state of a customer relationship of a customer or a set of customers with a company; and
based on the analysis of the customer insights, generating a recommendation corresponding to the state of the customer relationship.

2. The method of claim 1, wherein analyzing the group to derive the customer insights comprises:
for each group of customer interaction data, analyzing the group using an Artificial Intelligence (AI) model to derive the customer insights of the group.

3. The method of claim 1, wherein analyzing the group to derive the customer insights comprises:
for each group of customer interaction data, analyzing the group using a natural language processing (NLP) model and a rule-based system to derive the customer insights of the group.

4. The method of claim 3, wherein analyzing the group to derive the customer insights comprises:
for each group of customer interaction data,
extracting data including semantic meaning from each group of customer interaction data using the NLP model; and
applying a set of rules to the extracted data to derive the customer insights of the group.

5. The method of claim 1, wherein analyzing each group of customer interaction data to derive the customer insights comprises:
for each group of customer interaction data, analyzing the group to determine an intent of participants in a conversation, an outcome of the conversation, a vibe underlying the conversation, or any combination thereof.

6. The method of claim 1, wherein the customer insights comprise a next action to be performed, summary of a conversation, sentiment of the conversation, rule-based insights of the conversation, or any combination thereof.

7. The method of claim 1, further comprising:
prior to analyzing each group of customer interaction data, converting audio portion of the customer interaction data in each group to text using a speech recognition engine.

8. The method of claim 1, wherein generating the recommendation corresponding to the state of the customer relationship comprises:
generating the recommendation corresponding to the state of the customer relationship using an Artificial Intelligence (AI) model.

9. The method of claim 1, wherein each of the plurality of communication channels comprises one of a phone, email, messaging, social media, website search, website chatbot, in-person interaction, online conferencing, self-service portal, rule-based voice assistant interaction, or AI-based voice assistant interaction.

10. The method of claim 1, wherein receiving the customer interaction data from the plurality of communication channels comprises:
intercepting the customer interaction data in real-time from the plurality of communication channels corresponding to multiple business systems.

11. A system for managing customer conversation data, comprising:
a communication channel interface configured to receive customer interaction data from a plurality of communication channels corresponding to multiple business systems, wherein the customer interaction data is associated with a plurality of customers;
a data store configured to store the received customer interaction data associated with multiple business systems;
a processing unit configured to:
group the customer interaction data based on at least one of a topic, a timeline, and a user profile;
for each group of customer interaction data, analyze the group to derive customer insights of the group ;
analyze the customer insights of each group or across a plurality of groups to determine a state of a customer relationship of a customer or a set of customers with a company; and
based on the analysis of the customer insights, generate a recommendation corresponding to the state of the customer relationship.

12. The system of claim 11, wherein the processing unit is to:
intercept the customer interaction data in real-time from the plurality of communication channels corresponding to multiple business systems; and
store the intercepted customer interaction data in the data store.

13. The system of claim 11, wherein the processing unit is to:
analyze, for each group of customer interaction data, the group using an Artificial Intelligence (AI) model to derive the customer insights of the group.

14. The system of claim 11, wherein the processing unit is to:
for each group of customer interaction data, analyze the group using a natural language processing (NLP) model and a rule-based system to derive the customer insights of the group.

15. The system of claim 14, wherein the processing unit is to:
for each group of customer interaction data,
extract data including semantic meaning from each group of customer interaction data using the NLP model; and
apply a set of rules to the extracted data to derive the customer insights of the group.

16. The system of claim 11, wherein each of the plurality of communication channels comprises one of a phone, email, messaging, social media, website search, website chatbot, in-person interaction, online conferencing, self-service portal, rule-based voice assistant interaction, or AI-based voice assistant interaction.

17. A non-transitory computer-readable medium storing instructions executable by a processor of a computing device to:
receive customer interaction data from a plurality of communication channels corresponding to multiple business systems, wherein the customer interaction data is associated with a plurality of customers;
store the received customer interaction data in a data store;
group the customer interaction data based on at least one of a topic, a timeline, and a user profile;
for each group of customer interaction data, analyze the group to derive customer insights of the group;
analyze the customer insights of each group or across a plurality of groups to determine a state of a customer relationship of a customer or a set of customers with a company; and
based on the analysis of the customer insights, generate a recommendation corresponding to the state of the customer relationship.

18. The non-transitory computer-readable medium of claim 17, wherein instructions to analyze the group to derive the customer insights comprise instructions to:
for each group of customer interaction data, analyze the group using an Artificial Intelligence (AI) model to derive the customer insights of the group.

19. The non-transitory computer-readable medium of claim 17, wherein instructions to analyze the group to derive the customer insights comprise instructions to:
for each group of customer interaction data, analyze the group using a natural language processing (NLP) model and a rule-based system to derive the customer insights of the group.

20. The non-transitory computer-readable medium of claim 17, wherein instructions to receive the customer interaction data from the plurality of communication channels comprise instructions to:
intercept the customer interaction data in real-time from the plurality of communication channels corresponding to multiple business systems.
